(19) United States
(12) Patent Application Publication
(10) Pub. No.: US 2007/0086495 A1
(43) Pub. Date: Apr. 19, 2007

(54) Method and apparatus for stable laser drive

(76) Inventors: Randall B. Sprague, Camation, WA (US); Bin Xue, Mukilteo, WA (US); Gerald R. Apperson, Lake Forest Park, WA (US); Clarence T. Tegreene, Bellevue, WA (US); Christopher A. Wiklof, Everett, WA (US)

Correspondence Address: MICROVISION, INC., 6222 185TH AVENUE NE, REDMOND, WA, 98052, US

(21) Appl. No.: 11/499,309

(22) Filed: Aug. 3, 2006

Related U.S. Application Data
(60) Provisional application No. 60/707,854, filed on Aug. 12, 2005.

(51) Int. Cl. H01S 3/00

(52) U.S. Cl. 372/38.02

(57) ABSTRACT

A laser drive controller compensates for temperature-dependent effects of a temperature-sensitive laser. Temperature variations in the laser may be measured and/or predicted based on variable pulsed output. The controller may drive the laser to maintain temperature and/or to compensate for variations in temperature. The techniques may be applied to a laser scanner, scanned beam display, laser printer, laser camera, scanned beam imager, etc.

### CROSS REFERENCE TO RELATED APPLICATIONS

This application claims priority benefit from the U.S. Provisional Patent Application Ser. No. 60/707,854, entitled METHOD AND APPARATUS FOR STABLE LASER DRIVE, filed Aug. 12, 2005, invented by Randall B. Sprague et al., commonly assigned herewith and hereby incorporated by reference.

### BACKGROUND

Laser beams are used across a range of applications. It is frequently desirable to generate a laser beam using a solid state device. Laser diodes, for example, are commonly used to generate infrared, red, and violet beams. Some intermediate wavelengths such as green have been difficult to achieve directly with a laser diode. An approach used to achieve green laser beam output is to provide an infrared (IR) beam coupled to a component that converts the input beam into a shorter wavelength. Such a component is frequently referred to as a frequency doubling crystal or second harmonic generator (SHG). One exemplary application of an SHG is to generate a 1064 nanometer (nm) IR laser beam with an IR laser diode and pass it through the SHG to convert the 1064 nm IR beam to a 532 nm green laser beam. Various architectures have been developed for this including diode-pumped solid state (DPSS) and other architectures that use external cavities and/or external wavelength converters.

One type of device 101 for providing a green laser beam is shown schematically in FIG. 1. An infrared laser diode 102 is energized to output an infrared beam 104 at 1064 nm into an external cavity 106. The external cavity 106 includes a SHG 108 comprising periodically poled lithium niobate (PPLN) (periodically polled LiNbO₃). The infrared beam 104 enters the crystal 108 and is doubled in frequency to produce a halved wavelength of 532 nm. An output face of the external cavity 106 includes a mirror 110 that reflects substantially 100% of infrared light and about 90% of green light. The 90% of reflected green light continues to pass back and forth through external cavity 106 to make multiple passes through the SHG 108. The 10% of green light that passes through the mirror 110 is emitted as a green laser beam 112.

Another type of device 201 for providing a green laser beam is shown schematically in FIG. 2. An infrared laser diode 102 is energized to output a first infrared beam 202 at 808 nm into an external cavity 106. The external cavity 106 includes a down-converting crystal 204 that down-converts the frequency of the input beam 202 to produce a longer wavelength second infrared beam 104 at 1064 nm. Second infrared beam 104 enters a frequency doubling crystal (SHG) 108 comprising PPLN. As in the device 101 shown in FIG. 1, the second infrared beam 104 enters the crystal 108 and is doubled in frequency to produce a halved wavelength of 532 nm. An output face of the external cavity 106 includes a mirror 110 that reflects substantially 100% of infrared light and a high amount but less than 100% of green light. The green light that passes through the mirror 110 is emitted as a green laser beam 112.

Another type of device 301 for providing a green laser beam is shown schematically in FIG. 3. An infrared laser diode 102 is energized to output an infrared beam 104 at 1064 nm wavelength. The infrared laser beam 104 enters a PPLN SHG with Bragg grating and waveguide 302. A green laser beam 112 at 532 nm wavelength is emitted from the SHG with Bragg grating and waveguide 302. Some experts consider device 301 to be a single-pass device because an external mirror for providing multiple passes of the green light is omitted.

While the devices of FIGS. 1-3 are illustrated as internally generating a 1064 nm beam to produce a 532 nm output beam, other wavelengths may similarly be used. For example, a 1080 nm IR beam may be generated internally to produce a 540 nm output beam. Moreover, the technique may be used to produce blue, red, or even hyperspectral wavelength outputs. The apparatus and methods taught for stabilization of such devices should not be considered limited to driving devices producing particular exemplary wavelengths.

One consideration for using lasers such as devices 101, 201, 301, and other types of lasers relates to maintaining a relatively constant temperature within the devices. Unintended temperature variations in such devices can result in unintended variations in beam 112 output power. Unfortunately, some desired applications of such devices use beam modulation patterns that can result in corresponding modulation of heat dissipation within the devices, which in turn can cause variations in device temperature. While fans, liquid cooling, heaters, and thermostatically-controlled thermo-electric-coolers have been used with such devices, the response time of such systems is often greater than the time associated with temperature variations arising from modulation pattern variation. In certain applications, such as scanned beam displays, a desired pixel cycle time (pixel period) is somewhat shorter than the time constant for variable output induced variable heating, while a desired line period is somewhat greater than the time constant for variable output induced variable heating.

FIG. 4 illustrates the non-linearity of optical output power of a laser diode compared to driver current. A drive current trace 402 has a series of drive pulses 404, 406, 408, 410, 412, and 414 having increasing drive current interleaved with off segments 416a-416e. As may be seen by comparison of the heights and widths of the drive pulses to the line 418, the drive pulses increase monotonically and evenly and correspond to an intended series of laser pulses that similarly increase monotonically and evenly. A laser power output trace 420 has a series of light output pulses 422, 424, 426, 428, 430, and 432 corresponding to respective drive current pulses 404, 406, 408, 410, 412, and 414 and interleaved with non emitting segments 434a-434e. As may be seen by comparison of the heights and widths of the light output pulses to the line 436, the relative brightness of the laser power output pulses 422-432 do not correspond closely to the driver pulses 404-414. In particular, some pulses are considerably narrower than the drive current pulses and some pulses undershoot the intended output brightness. The combination of varying pulse heights and widths results in erratic apparent brightness of the pulses compared to the input energization signal 402.

### OVERVIEW

One embodiment according to the invention relates to methods and apparatuses for scanning variably modulated beams of light emitted from a laser that is sensitive to variable modulation. According to one embodiment, such lasers may be stabilized by providing stabilization or thermal compensation pulses at a current or through a current path that does not result in substantial lasing, but does provide power dissipation, thus maintaining relatively constant heat flow through the device even in the absence of laser emissions. By maintaining a relatively constant heat flow, as measured over periods corresponding to one to several pulses, the temperature of the device may be maintained relatively constant, thus stabilizing optical power output.

According to one embodiment stabilization pulses are provided through the normal laser modulation current path at a current below the lasing threshold current for the device. Such stabilization pulses may be provided, for example, during portions of the cycle lying between nominal light output portions, or in the case where no light is output during a given cycle, during the period when light output normally occurs.

According to another embodiment, stabilization pulses are provided through the normal laser modulation current path at a current above a rollover threshold for the device. At high current levels above a rollover threshold, some devices do not emit substantial amounts of light and such current levels may be used to provide power dissipation with light pulses being enabled by modulating down from above the rollover threshold.

According to another embodiment, stabilization pulses are provided through the normal laser modulation current path with a duration shorter than the rise time of the laser.

According to another embodiment, stabilization pulses are made through a power dissipation current path different from the laser modulation current path, for example through a resistor held in close contact to the laser device. Such pulses may be made simultaneously with or sequential to laser modulation pulses.

According to some embodiments, stabilization pulses are determined from the modulation data alone. According to other embodiments, a temperature sensor or other sensor may additionally provide input for determining appropriate stabilization pulses. Modulation data may be used at a single pulse level to determine a corresponding stabilization pulse. Alternatively or additionally, a series of modulation data may be analyzed to determine corresponding stabilization pulses. For cases where a series of modulation data is analyzed, such data may include future and past modulation activity.

According to some embodiments, laser stabilization techniques may be combined with other approaches adapted to reducing or accommodating noise and other variability from laser sources. Some such other approaches are taught in U.S. patent application Ser. No. 10/933,033 entitled Apparatuses and Methods for Utilizing Non-ideal Light Sources, invented by Margaret Brown et al., filed Sep. 2, 2004 and hereby incorporated by reference.

According to some embodiments a stabilized laser is used in a scanned beam display such as a head-up display, head-worn display, a microdisplay embedded in a device such as a cell phone or camera, a projection display such as a personal computer projector (beamer), a rear projection or front projection television, and other types of displays.

According to other embodiments, a stabilized laser is used in a scanned beam image capture device such as a laser camera, a scanned beam endoscope, a bar code scanner, a confocal image capture device, and other types of image capture devices.

Other aspects will become apparent to the reader through reference to the appended brief description of the drawings, detailed description, claims, and figures.

### BRIEF DESCRIPTION OF THE DRAWINGS

FIG. 1 is a diagram illustrating one type of laser that may be sensitive to temperature variations.

FIG. 2 is a diagram illustrating another type of laser that may be sensitive to temperature variations.

FIG. 3 is a diagram illustrating still another type of laser that may be sensitive to temperature variations.

FIG. 4 is a storage oscilloscope output comparing the output power of a laser diode that is sensitive to temperature variations compared to input current, according to an embodiment.

FIG. 5 is a flowchart showing a general method for providing a compensation signal to improve the correspondence of laser light output to intended brightness, according to an embodiment.

FIG. 6 is a flowchart showing a variation of the method of FIG. 5 wherein the compensation signal is combined with a laser modulation pattern, according to an embodiment.

FIG. 7 is a diagram illustrating the optical output power of a pulsed laser as a function of drive current according to an embodiment.

FIG. 8 illustrates a combined laser modulation pattern and thermal compensation or stabilization pattern according to an embodiment where stabilization pulses are made below a lasing threshold.

FIG. 9 is a storage oscilloscope output comparing the output power of a laser diode compared to input pulses that include thermal compensation or stabilization pulses, according to an embodiment.

FIG. 10 is a diagram illustrating a combined laser modulation pattern and a thermal compensation or stabilization pattern wherein the stabilization pulses are made above a rollover threshold of the laser, according to an embodiment.

FIG. 11 is a diagram illustrating a combined laser modulation and thermal compensation pattern wherein the stabilization pulses have a duration shorter than the rise time of the laser, according to an embodiment.

FIG. 12 is a diagram of a laser having a separate current path for power dissipation, according to an embodiment.

FIG. 13 is a diagram illustrating a separate laser modulation and thermal compensation or stabilization patterns wherein stabilization pulses may be driven through a separate conduction path, according to an embodiment.

FIG. 14 is a diagram illustrating a combined laser modulation pattern and thermal compensation or stabilization pattern wherein stabilization for a given pixel may be made over a plurality of pixel clock cycles, according to an embodiment.

FIG. 15A is a partial simplified compensation controller block diagram for the generation of distributed thermal compensation waveforms using future and/or past pixel values, according to an embodiment.

FIG. 15B is a partial simplified compensation controller block diagram for the generation of thermal compensation waveforms using the current pixel value, according to an embodiment.

FIG. 16A is a diagram illustrating some of the principal components of an RGB scanned laser beam display, according to an embodiment.

FIG. 16B schematically illustrates a scanned beam display system used as a head up display, for example as a heads-up display in a motor vehicle, according to an embodiment.

FIG. 17 is a diagram illustrating some of the principal components of an RGB scanned laser beam image capture device, according to an embodiment.

FIG. 18 is a diagram illustrating a field of view of a scanned beam system according to an embodiment.

### DETAILED DESCRIPTION

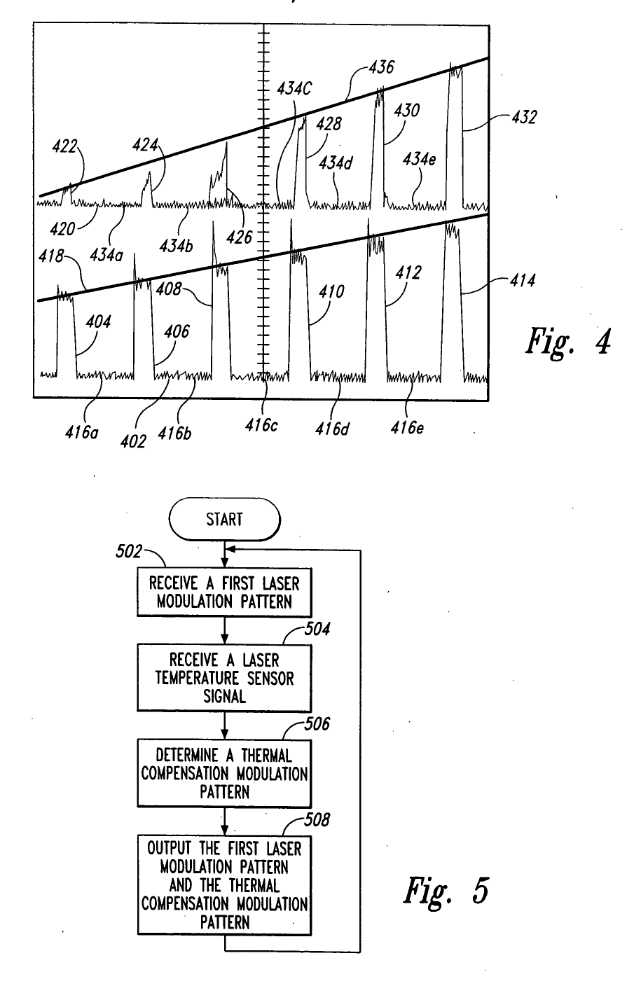

FIG. 5 illustrates, in flow chart form, a general approach to compensating to avoid unintended variations in light output, such as the variations illustrated by FIG. 4. In step 502, a laser modulation pattern is received. Such a pattern may, for example, correspond to a series of intended grayscale pixel values in a scanned beam display. The first laser modulation pattern received in step 502 may comprise a single pixel value, or may comprise a sequence of pixel values, depending upon the embodiment. It may correspond to a single laser emitter or may correspond to a plurality of laser emitters, depending upon the embodiment.

Proceeding to optional step 504, a signal is received indicating a measured temperature, which may for example be a measured temperature of the laser to be driven, an ambient temperature, or another characteristic temperature such as the temperature of a heatsink. Step 504 is an option in some embodiments.

In step 506, a thermal compensation modulation pattern is determined from the first laser modulation pattern received in step 502, and optionally from the temperature sensor signal received in step 504. Generally speaking, a thermal compensation modulation pattern may be formed to have a relatively high amount of cumulative power output when the cumulative power output of the first laser modulation pattern is relatively low, and the thermal compensation modulation pattern may be formed to have a relatively low amount of cumulative power output when the cumulative power output of the first laser modulation pattern is relatively high. For embodiments where a temperature sensor signal is also received, the value may further inform the formation of the thermal compensation modulation pattern. For example, if the temperature is relatively high, the cumulative power output of the thermal compensation signal may be reduced or eliminated and when the temperature is relatively low, the cumulative power output of the thermal compensation signal may be increased.

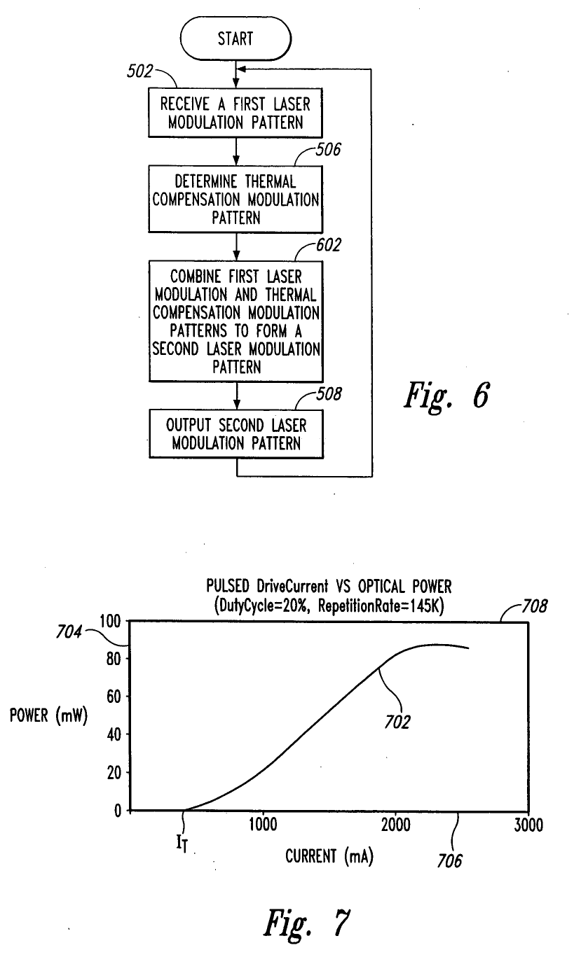

Finally, in step 508 the first laser modulation pattern and the thermal compensation modulation pattern are outputted. The signals may be outputted as separate signals or alternatively, may be combined into a single signal is indicated in FIG. 6 below. According to some embodiments, the first laser modulation pattern may be varied responsively to the laser temperature signal. According to some embodiments, the first laser modulation pattern is a function both of a pattern of pulses emitted and a laser temperature signal.

FIG. 6 is a flow chart illustrating a method wherein the first laser modulation pattern and the thermal compensation modulation pattern are combined into a single pattern, shown in step 602, called the second laser modulation pattern. In the example of FIG. 6, a temperature sensor signal is omitted. In step 602, the first laser modulation pattern and the thermal compensation modulation pattern are combined to form a second laser modulation pattern having combined attributes.

Use of the signals output in step 508 of FIGS. 5 and 6 will be described below.

Turning now to FIG. 7, a curve 702 indicates an illustrative embodiment where the optical output power 704 as a function of drive current 706 under nominal pulsed operating conditions. One can see that below a threshold current I_{T} 708, substantially no light is output by the laser. Above the threshold current, light output power increases, for example, monotonically, with drive current until a rollover region is reached where output power no longer increases. At a high rollover current, light output may decrease to substantially zero.

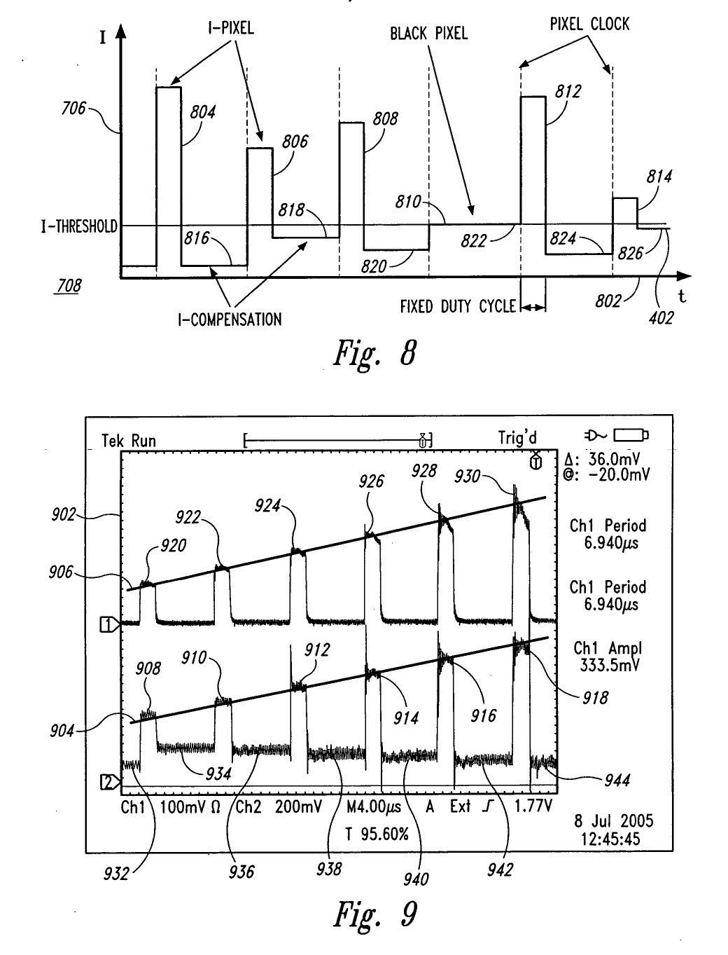

FIG. 8 illustrates an idealized combined laser modulation pattern and thermal compensation pattern according to one embodiment. A laser drive waveform 402 comprising a plurality of pulses is shown as a function of time along a time axis 802. Laser drive output current is shown on the vertical axis 706. As may be seen, a threshold current 708 is shown as a horizontal line across the graph. As may be appreciated from the discussion related to FIG. 7, portions of the waveform 402 that fall below the threshold current 708 do not result in light output from the laser.

The plurality of laser modulation pattern pulses 804, 806, 808, 810, 812, and 814 correspond to a plurality of intended laser output powers. As may be seen, pulse 804 corresponds to a relatively high desired brightness, pulse 812 to a somewhat lower brightness, pulses 808, 806 and 814 to successively lower brightness, and pulse 810, to no light. As is shown, pulse 810 does not exceed the threshold current 708 and is therefore a zero-value pulse. It may also be seen that the pulses occur, in this example, at a fixed repetition frequency indicated by the vertical dashed lines and that they are separated by a corresponding series of interleaved periods 816, 818, 820, 822, 824, and 826. While the time periods represented by the pulse stream 402 are shown as uniform, it is not necessary for such time periods to be uniform. As will become clear from the discussion below, the method and apparatuses taught herein may be easily adapted to a non-constant pulse frequency.

It may also be seen that the current of the interleaved periods are not uniform, but rather are varied in a manner inversely proportional to the height of the preceding modulation pattern pulse. The interleaved periods 816 to 826 are termed compensation pulses. Because the compensation pulses 816 to 826 are at a drive current that falls below the threshold current 708, they do not produce light output. Instead, the compensation pulses 816 to 826 are used to create a relatively uniform rate of power dissipation in the laser, even though the current of the light modulation pulses is not uniform.

Light output pulse 804 is at a relatively high level. Compensation pulse 816 is thus set to a relatively low level. In comparison, light output pulse 814 is at a relatively low level, and corresponding compensation pulse 826 is set to a relatively high level. Generally speaking, the compensation pulse current is selected to provide relatively uniform average power dissipation, and therefore relatively uniform average laser heating, over each period. Thus the integrated power dissipation during the first period comprising light output pulse 804 and compensation pulse 816 is substantially equal to the integrated power dissipation during the second period comprising light output pulse 806 and compensation pulse 818. The subsequent periods similarly have substantially equal integrated power dissipation. The black pixel pulse 810 and its corresponding compensation pulse 822 are selected to be just below or at the threshold current 708 and therefore meld with one another with no apparent edge in between.

According to some embodiments, the cumulative amount of power dissipated during each respective pixel cycle need not necessarily be maintained absolutely constant, but may rather be made relatively constant. That is, a particularly bright pixel may dissipate somewhat more power than the average pixel, even when the drive current is held at zero between pulses, and a particularly dark pixel may dissipate somewhat less power than the average pixel, even when the drive current is held just below the threshold current over the duration of the pixel period. The acceptable or desirable power dissipation variability during given pixel periods may vary according to the temperature sensitivity of the laser, the acceptable variability or noise in the output pixel brightness, the thermal time constant of the laser, the variability in the pixel period, etc.

While the approach of FIG. 8 and other embodiments shown herein depict compensation for a moderate number of finite laser brightnesses, embodiments of the invention are not so limited. For example, with appropriate controller hardware and logic, continuously varying brightnesses may be compensated for. Similarly, single-bit (on-off) brightnesses may be compensated for, for example by choosing illumination and compensation patterns corresponding to only the pulses 804, 816 corresponding to the first pixel period and the 810, 822 pulses corresponding to the fourth pixel period.

Moreover, while the pixel periods are shown as constant in FIG. 8 and FIGS. 10-13, pixel periods may be varied. For example, sinusoidal scan patterns typically use relatively shorter pixel periods near the center of a field of view and relatively longer pixel periods near the edges of the field of view. The schedule relating desired pixel brightness to thermal compensation may be varied across a scan line, for instance by maintaining a relatively constant power dissipation rate even though the pixel period is varied.

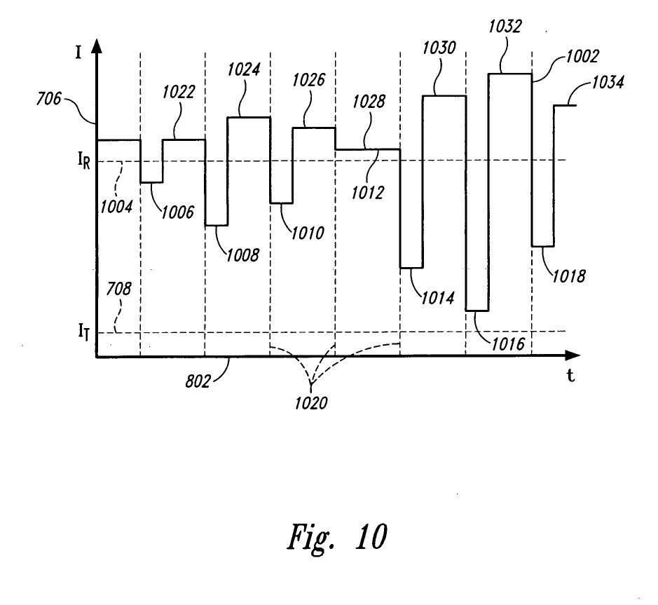

FIG. 9 is a storage oscilloscope output showing a series of light output pulses 902 compared to input modulation 904 that includes stabilization or thermal compensation pulses. As may be seen, the resultant light output pulses maintain a relatively constant pulse width across a range of brightness levels and generally reach a desired peak brightness, as indicated by line 906. Input modulation 904 includes laser modulation pulses 908, 910, 912, 914, 916, and 918 corresponding to respective light output pulses 920, 922, 924, 926, 928, and 930. Thermal compensation or stabilization pulses in input modulation 904 may be seen by comparing to a zero output drive level 932. Thus, the first, low power laser modulation pulse 908 is followed by a relatively high current stabilization pulse 934. Similarly the second, somewhat higher power laser modulation pulse 910 is followed by a somewhat lower current stabilization pulse 936. This trend may be seen to follow as progressively higher laser modulation pulses 912, 914, 916, and 918 are followed by progressively lower respective stabilization pulses 938, 940, 942, and 944. As described above, the stabilization pulses 934, 936, 938, 940, 942, and 944 are made inversely proportional to the associated laser modulation pulse and, being below the lasing threshold of the device, do not result in any substantial amount of laser radiation from the laser, but rather serve to provide power dissipation in an amount that results in substantially constant dissipation through the device, regardless of the pulse brightness from the laser. This allows, for example, a video signal having variable and arbitrary brightness pixels to be scanned across a field of view wherein the pixels reach their intended brightness, rather than a different or variable brightness.

FIG. 10 is a diagram, according to an embodiment, illustrating a combined laser modulation and thermal compensation or stabilization pattern 1002 on current 706 versus time 802 axes, wherein the stabilization pulses are made above a rollover threshold I_{R} 1004 of a laser. As mentioned above, some lasers have a maximum current at which they will emit light, wherein current applied above the maximum current, termed the rollover threshold, results in substantially no light being emitted. A series of laser modulation pulses 1006, 1008, 1010, 1012, 1014, 1016, and 1018 are made according to a pixel clock illustrated by vertical dashed lines 1020. As may be seen, the laser modulation pulses 1006-1018, with the exception of black pulse 1012, extend from above the rollover threshold 1004 down to a current between the threshold current I_{T} 708 and the rollover threshold I_{R} 1004. That is, a given laser pulse (with the exception of black, non-illuminating pulses) is made at a current below the current dissipated by the laser between pulses.

As may be seen, a relatively high brightness pulse 106 is followed by a compensation pulse 1022 that is relatively low, but above the rollover current 1004. A somewhat lower brightness pulse 1010 is paired with a somewhat higher compensation pulse 1026. This trend may be seen throughout the modulation and stabilization pattern 1002 as respective progressively dimmer (lower current) light modulation pulses 1008, 1018, 1014, and 1016 are paired with progressively higher current compensation pulses 1024, 1034, 1030, and 1032. A black or null pixel is formed by a combined pulse 1012 and 1028 that holds the current just above the rollover threshold 1004 throughout the duration of the pixel period 1020.

Thus, in a manner akin to that shown in FIG. 8, the method of FIG. 10 provides a relatively constant amount of power dissipation through a laser even thought the application calls for a variable pattern of light output. Relatively low optical power pulses such as 1016 and 1014 are paired respectively with relatively high power thermal compensation pulses 1032 and 1030. Relatively high optical power pulses such as 1006 and 1010 are paired respectively with relatively low power thermal compensation pulses 1022 and 1026. Black pulses such as 1012 are made, according to the illustrated embodiment, by keeping the drive current just above the rollover current 1004 such that an appropriate amount of power is dissipated over the period while substantially no light is emitted.

In addition to being characterized by threshold current and rollover current, lasers may be characterized by bandwidth or maximum modulation frequency. Lasers may be designed to modulate below a given cut-off frequency but not output light when modulated above the cut-off frequency. The bandwidth characteristics of a given type of laser may be characterized by a rise time, wherein an energization pulse must be applied to the laser for a period at least as long as its rise time before any substantial amount of light is emitted. FIG. 11 is a diagram illustrating a combined laser modulation and thermal compensation or stabilization pattern 1101 wherein the stabilization pulses have durations shorter than the rise time of the laser.

As with FIGS. 8 and 10, FIG. 11 shows a combined laser modulation and thermal compensation or stabilization pattern 1101 on current versus time axes, 706 and 802, respectively. A high brightness pulse 1102 precedes a medium brightness pulse 1104. These pulses are followed respectively by medium-bright pulse 1106, black or null pulse 1108, high brightness pulse 1110, low brightness pulse 1120, and medium brightness pulse 1114 as time progresses from left to right. As may be seen, the high brightness pulse 1102 during the first illustrated full pixel period 1020 has sufficient power dissipation that substantially no additional compensation power is dissipated during subsequent compensation pulse 1116. Subsequent medium brightness pulse 1104, however, does not dissipate the desired amount of power during the subsequent period 1020 and additional compensation power is dissipated during subsequent compensation period 1118. In contrast with the approaches shown above, however, the compensation pulse 1118 comprises a plurality of short on-off sub-pulses, with the on periods being held to durations shorter than the rise time of the laser. Thus, sub-pulses of compensation pulse 1118 are expressed in the laser substantially as heat dissipation rather than light emission (although the designer may opt to output some small amount of light during the heat dissipation pulses).

Similarly, medium-bright pulse 1106 is paired with a compensation pulse 1120 that dissipates somewhat more thermal energy than the compensation pulse 1118 but less thermal energy than the compensation pulse 1116 paired with bright illumination pulse 1102. The dark or null pixel 1108 is comprised only of short power dissipation on-off pulses that carry through its paired compensation pulse 1122. This results in thermal power dissipation that is close to the amount of power dissipated during other pixel periods 1020, but results in substantially no light emission. Bright pulse 1110 is similar to bright pulse 1102 in that it is paired with a similar low power compensation pulse 1124, and low brightness pulse 1112 is paired with a relatively high power compensation pulse 1126.

Also shown in FIG. 11 is a laser temperature curve 1128, plotted as temperature T 1130 along a common time axis 802. Pixel periods 1120 are shown extending from the pulse pattern curve to the laser temperature curve to illustrate the correspondence of the curves.

In the example of FIG. 11, a laser device has a preferred temperature operating range between a minimum temperature Tₘᵢₙ 1132 and a maximum temperature Tₘₐₓ 1134. Thus, it is desirable to keep the temperature of the laser, indicated by curve 1128, between these two extremes. As may be seen, the temperature rises during light emission pulses and falls during periods of non-energization. Compensation pulses are made in the during the times 1116, 1118, 1120, 1122, 1124, and 1126 between light pulses as necessary to keep the temperature of the device above Tₘᵢₙ 1132. As may be seen, high brightness pulses 1102 and 1110 create a relatively large corresponding temperature rise in the laser temperature curve 1128. The lack of compensation pulses during the paired compensation periods 1116 and 1124 allows the laser to cool back down to a level closer to Tₘᵢₙ 1132, thus preparing the laser for the next light emission pulse, which will again cause a temperature rise to some higher level. As may be seen, the amount of compensation energy dissipated through the laser is chosen to bring the temperature of the laser back to approximately the same level for the start of each light emission pulse. During the black pixel pulse 1108, the laser may receive compensation pulses for the entire pixel period to maintain its temperature.

While the temperature response 1128 is idealized in that the same temperature is returned to for each light emission pulse, the system need not necessarily be so constrained. As will be seen in conjunction with FIG. 14, it may be possible in some systems to allow for relatively wider swings in temperature and the system may optionally cause the temperature of the laser to return to a desired level over a series of pixel periods. The system may similarly prepare for a period of relative inactivity (low brightness or black pixels) by raising the temperature prior to the period such that a desired nominal operating temperature range is substantially maintained for the duration of the period of relative inactivity.

While the on-off pulses made during the compensation pulses of waveform 1101 are shown as being about one-quarter the duration of the light emission pulses and the duty cycle during the compensation period of the compensation pulses is shown as being about 50%, other values may be selected according to the application. For example, the scan rate and addressability of a scanned beam system may be such that the pixel periods 1020 range from about 20 to 30 nanoseconds (nS), varying sinusoidally across the field of view. Light emission pulses may be chosen to last about 10 nS with the compensation pulses comprising the remainder of the pixel periods. The on sub-pulses during the compensation pulses may be chosen to last about 1 nS, or about one order of magnitude shorter than the light emission pulses. Accordingly, a laser bandwidth or cutoff frequency may be chosen to fall between a frequency corresponding to the illumination pulses and the compensation sub-pulses. In this example, the 10 nS illumination pulses correspond to a frequency of about 100 mega-Hertz (MHz) and the 1 nS sub-pulses correspond to a frequency of about 1 giga-Hertz (GHz). It is sometimes desirable for a device bandwidth to be at least three times a designed pulse frequency, so a suitable laser bandwidth for the example could be about 300-500 MHz, corresponding to a rise time of about 2 to 3 nS. The drive circuit may, for example, have a bandwidth of about 3 GHz to support the relatively high frequency of the sub-pulses. The ratio of frequencies of the compensation sub-pulses to the illumination pulses may be modified to further optimize the system, for example by shortening the sub-pulses to allow for dissipating heat through a laser having a bandwidth higher than about 3 GHz while still avoiding light output during the compensation period. Other ranges may be appropriate depending on things such as resolution, scan rate, number of beams, etc.

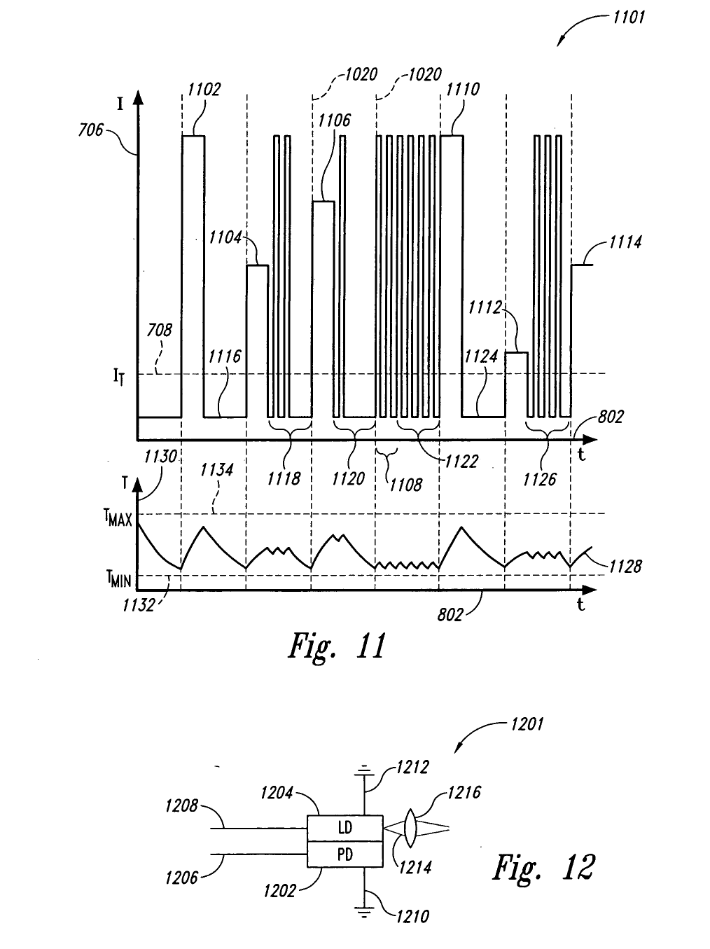

As an alternative to dissipating compensation pulses through the same current path as the light emission pulses, a laser may be configured to have an alternative, non-illuminating current path. According to one example, diagrammatically shown in FIG. 12, a non-light emitting diode or power diode PD 1202 may be packaged in close proximity to a laser diode LD 1204 with separate or switched respective current sources 1206, 1208 and grounds 1210 and 1212. As shown, the power diode 1202, which may contain internal resistance corresponding to the resistance of the laser diode 1204, is constructed from a separate die and bonded subjacent to and thermally coupled to the laser diode 1204. Laser diode 1204 is aligned to emit an output beam 1214 through a lens 1216. Alternatively, the power dissipation current path may, for example, be configured as a neighboring, on-die device with no lasing cavity, and/or no light guide, and/or no exit facet, with an oppositely oriented exit facet, etc. Alternatively, an alternative power dissipation path may comprise a resistor or other device thermally coupled to the laser.

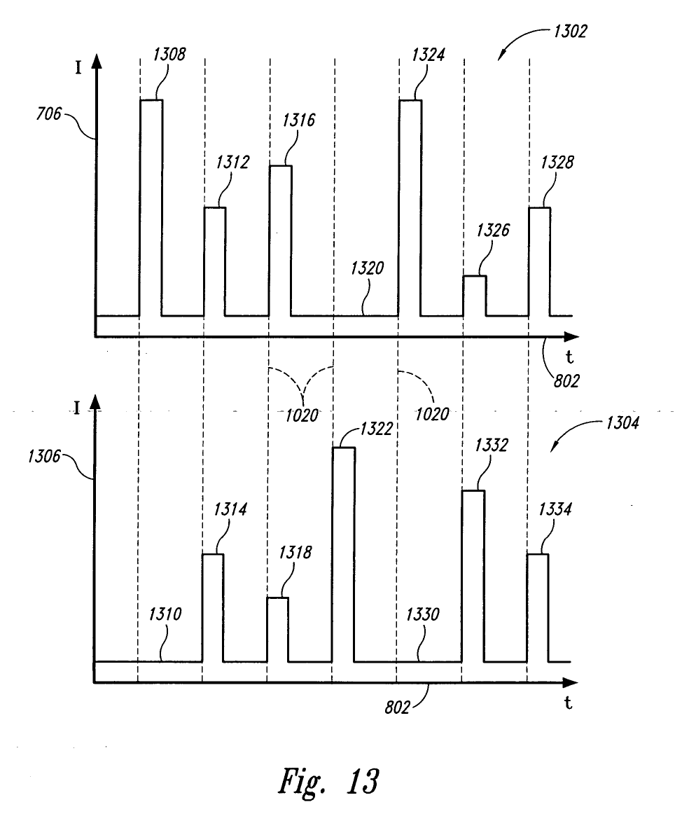

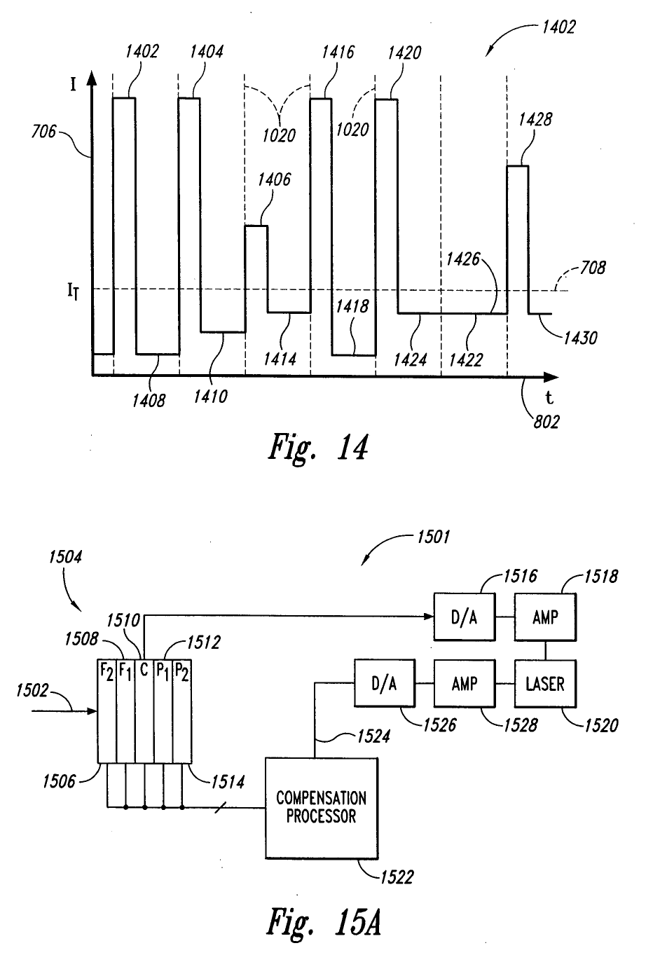

FIG. 13 is a diagram illustrating a separate laser modulation pattern 1302 and thermal compensation or stabilization pattern 1304, wherein stabilization pulses are driven through a separate conduction path such as, for example, through a power diode 1202 as shown in FIG. 12. The waveforms 1302 are shown plotted as respective current 706 and 1306 along common time axes 802 aligned vertically. Pixel periods 1020 are shown extending between axes, illustrating the correspondence of the periods across both waveforms 1302 and 1304.

A high brightness, high current laser emission drive pulse 1308 is shown with a corresponding low current thermal compensation pulse 1310. Since the pulse 1308 results in a target amount of thermal dissipation during the first pixel period 1020, no additional thermal dissipation is desired, and as such thermal compensation pulse 1310 is kept at a very low level. A medium brightness emission pulse 1312 is paired with a medium thermal compensation pulse 1314. The relative amounts of current dissipation may be chosen to provide current dissipation during the second period 1020 (i.e. during the period corresponding to laser pulse 1312 and thermal compensation pulse 1314) approximately equal to the current dissipated by the high brightness laser drive pulse 1308 during the first period 1020. Similarly, a medium-bright laser emission pulse 1316 is paired with a medium-low thermal compensation pulse 1318, again resulting in relatively constant total thermal dissipation during the period 1020. A black or null pixel is driven by the laser emission pulse 1320 having substantially no height and is paired with a high current thermal compensation pulse 1322, again resulting in substantially constant total thermal dissipation during the period 1020. Following the dark pixel, respective high, low, and medium brightness laser emission pulses 1324, 1326, and 1328 are paired with corresponding thermal compensation pulses 1330, 1332, and 1334 in the manner shown.

Thus, a relatively constant temperature is maintained in the laser by providing inversely proportional laser illumination and thermal compensation waveforms 1302 and 1304. Although the respective laser illumination and corresponding thermal compensation pulses are shown as occurring simultaneously in FIG. 13, such pulses may alternatively be offset during respective periods. Alternatively, the thermal compensation pulses may be distributed across a sequence of pixel periods or arranged in other ways.

FIG. 14 illustrates a waveform 1402 comprising a sequence of laser illumination pulses and thermal compensation pulses wherein the thermal compensation pulses corresponding to a given laser illumination pulse may be distributed across a sequence of pixel periods 1020. A first, high brightness pixel illumination pulse 1402 is followed by a second high brightness pixel illumination pulse 1404, which is followed by a low brightness, low power pixel illumination pulse 1406. Corresponding thermal compensation pulses 1408, 1410, and 1414 are shown. The first corresponding thermal compensation pulse 1408 is shown dissipating very little or zero power. Since it falls between two high power illumination pulses 1402 and 1404, no additional power dissipation is needed to maintain the laser temperature in an appropriate range. The second thermal compensation pulse 1410, however, is shown at a higher current than would normally be expected with respect to its corresponding laser illumination pulse 1404. This is because the subsequent laser illumination pulse 1406 is low enough current that its corresponding thermal compensation pulse 1414 is incapable of outputting sufficient thermal compensation energy during its allotted period to maintain the desired laser temperature while remaining below the lasing threshold 708. Instead, the controller looks ahead at the future (F₁) laser emission pulse and adjusts the present thermal compensation pulse 1410 upward to share some of the thermal compensation workload. Thus, the thermal compensation corresponding to the low brightness laser illumination pulse 1406 is spread over two successive thermal compensation pulses 1410 and 1414. Taken together, the two successive thermal compensation pulses 1410 and 1414 are, according to the example, sufficient to provide thermal compensation for the low brightness laser illumination pulse 1406.

Proceeding to the right, bright pixel laser drive pulse 1416 is followed by a low power thermal compensation pulse 1418. This is followed by a bright laser drive pulse 1420. This time, however, the controller again looks ahead and sees that the next laser illumination pulse 1422 is a black or null pixel and so the thermal compensation pulse 1424 associated with laser illumination pulse 1420 is adjusted to a high level to begin compensation for black laser illumination pulse 1422. Black laser illumination pulse 1422 is followed by a thermal compensation pulse 1426 set just below the lasing threshold. According to the example, the combination of thermal compensation pulses 1424 and 1426 are not quite sufficient to maintain the laser temperature at a nominal value. A subsequent high power laser illumination pulse would be sufficient to again raise the temperature to a desired range, but the pixel map instead calls for a medium power laser drive pixel 1428. Thus, the controller looks back and determines that the thermal compensation pulse 1430 associated with medium power laser drive pixel 1428 should be adjusted upward a bit to provide extra power dissipation to compensate for the previous black pixel 1422. Accordingly, thermal compensation pulse 1430 is set just below the lasing threshold 708 to raise the laser temperature back to its desired range.

While the pattern indicated in FIG. 14 illustrates the use of both look-ahead and look-back logic to determine the value of thermal compensation pulses, just one or just the other may suffice for a given application. Furthermore, compensation logic may be extended beyond only one future and/or one previous pulse in determining an appropriate thermal compensation pulse value.

Moreover, while the combined laser illumination and distributed thermal compensation waveform 1402 is illustrated as corresponding to the approach of FIG. 8, the approaches of FIGS. 10, 11, 13 or combinations thereof may be used.

The look-ahead feature illustrated by FIG. 14 may be used to advantage in intermittently used systems. For applications where no light need be emitted for extended periods, the laser may be allowed to cool. This may be used, for example, to reduce power consumption, increase laser life, increase safety, etc. When an indication of impending laser emission is received, for example as a new video frame begins to be received or when a trigger pull in a scanned beam imager is sensed, the compensation controller may transmit warm-up pulses to the laser to raise its temperature to or near an optimal or nominal operating temperature. This may be used even in systems that do not exhibit variable laser emissions during use, but rather may use a relatively constant duty cycle.

Alternatively, the approaches described herein may be used in combination with image compensation. According to such an approach, thermal compensation may be used to improve the consistency of the laser temperature, but not necessarily maintain temperature closely enough to prevent mode-hopping or output variation altogether. In such a system, various approaches to compensation logic may be used. For example, a pixel-value-to-code look-up table may include a variable related to the mode (or the output efficiency) that the laser is in or predicted to be in. When the laser is in a low output state, the code value used to drive the laser drive amplifier may be increased somewhat to provide extra current or extra on-time sufficient to overcome the reduced output. Conversely, the designer may choose to operate the laser in a less-than-maximum efficiency mode. When the laser is heated so as to increase the efficiency above the nominal design efficiency, laser drive power or duration may be decreased correspondingly.

The choice to drive the laser in a less than maximum-output mode may, of course, be implemented whether or not image compensation is used. Such an approach may be used to add control authority or range to a system, compensate for part aging, part-to-part variations, or system alignment, respond to brightness control input, etc.

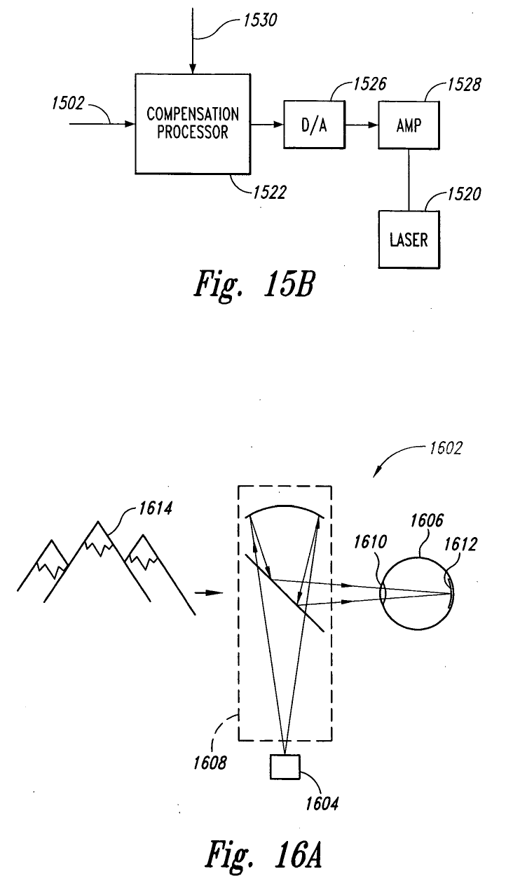

FIG. 15A is a block diagram of a simplified controller adapted to compensate for laser illumination pulses over a plurality of compensation periods. An input data stream 1502, which may for example be a video data stream, is received. A first pixel value is received in a memory array 1504 and loaded into a first partition F₂ 1506, the width of which is determined according to the bit depth of the pixel value. The contents of first partition 1506 represent the second future grayscale value to be output by a laser. At the beginning of the next pixel period, the contents of the first partition 1506 are shifted to a next memory partition F₁ 1508 and the subsequent pixel value is loaded into first partition 1506. This process continues, with new pixel grayscale values being received in the first memory partition F₂ 1506, then shifted sequentially through the second memory partition F₁ 1508, a third memory partition C 1510, a fourth memory partition P₁ 1512, a fifth memory partition P₂ 1514, and then dumped with each new pixel period. According to the example of FIG. 15, F₂ 1506 represents the second future pixel grayscale value desired to be produced by the laser; F₁ 1508 represents the future or next pixel grayscale value, C 1510 represents the current pixel grayscale value, P₁ 1512 represents the past pixel grayscale value, and P₂ 1514 represents the second past pixel grayscale value.

In some applications, and particularly in applications that use separate pixel illumination and thermal compensation current paths, the grayscale pixel illumination value held in the C or current memory partition 1510 can be read and the value used to drive an optional first digital-to-analog converter (D/A) 1516, the signal from which is amplified by and optional first amplifier 1518 and used to drive the laser emission pulses of laser 1520. Additionally or alternatively, the pixel values held in memory partitions 1506-1514 are read by a compensation processor 1522. Compensation processor 1522 produces a series of digital pulses on output 1524 that are used to drive a second D/A 1526. The output of D/A 1526 is amplified by amplifier 1528. The amplified output of amplifier 1528 then drives a current dissipation path in laser 1520.

In cases where optional D/A 1516 and optional amplifier 1518 are not used, the output of amplifier 1528 is used to drive at least the light emission current path of laser 1520. For cases where optional D/A 1516 and optional amplifier 1518 are not used, amplifier 1528 may optionally also be used to drive a second power dissipation current path in the laser 1520. For cases where the optional D/A 1516 and optional amplifier 1518 are used, the laser light emission is driven from optional amplifier 1518 and the amplifier 1528 is used to drive the second power dissipation current path in laser 1520.

The compensation processor 1522 may be implemented in a variety of ways such as, for example, a programmable microprocessor or microcontroller, an application-specific integrated circuit (ASIC), a field-programmable gate array (FPGA), a programmable array logic device (PAL), a gate array, discrete circuitry, and/or other forms, along with associated circuitry.

The memory array 1504 and associated pixel value shifting may be implemented in a variety of ways including as a single memory device or a portion of a single memory device and as separate discrete memory devices such as shift registers, FIFOs, etc. The location of a given pixel value may remain fixed with a rotating pointer determining the relative positions of pixel values or the data may be physically shifted from location to location. All or parts of the compensation system 1501 may comprise a portion of a larger controller or may comprise a purpose-specific controller.

A simplified compensation controller block diagram is shown in FIG. 15B. The compensation processor 1522 and other components of FIG. 15B operate in a manner similar to that described in conjunction with FIG. 15A except that past and future pixel activity is not considered in determining a compensation waveform.

As with the arrangement of FIG. 15A, compensation processor 1522 of FIG. 15B may optionally output separate laser illumination and laser thermal compensation waveforms, an arrangement that may be especially useful in conjunction with lasers having a separate heater conduction path, such as the example shown in FIG. 12. Such an embodiment may use a separate output (not shown) to carry a compensation waveform such as waveform 1304 of FIG. 13.

FIG. 15B additionally shows an optional pixel period input 1530 that may also be used in conjunction with the compensation controller of FIG. 15A. Pixel period input 1530 may input a pixel clock, a scan velocity indication, a pixel location indication, etc. When a variable pixel clock is used, as described below, for example, the pixel period input 1530 may be used by the compensation processor 1522 to create a compensation waveform that provides substantially constant power dissipation through the laser per unit time, rather than per pixel clock cycle. For example, when the beam of a sinusoidally scanned system is near the center of the field of view, its velocity may be significantly higher than when the beam is near the edge of the field of view. In such a case, a reduced amount of compensation power may be applied during a pixel cycle corresponding to the location near the center of the field of view, compared to the amount of compensation power that is applied during pixel cycles corresponding to locations near the edge of the field of view, for example. By varying the relative amount of compensation energy in a manner proportional to the pixel cycle time (shorter cycles receive relatively less compensation energy, longer cycles receive relatively more compensation energy) the amount of power dissipation through the laser may be kept constant per unit time, thus keeping the temperature of the device more nearly constant.

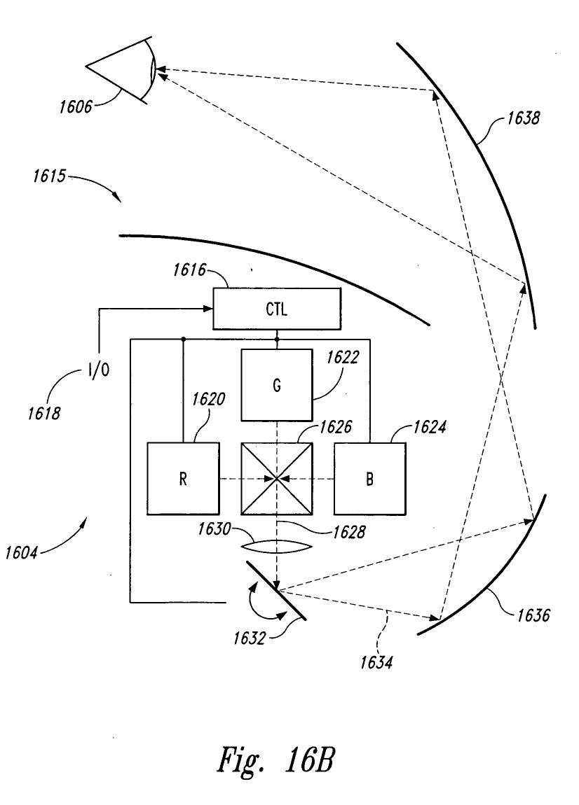

One application for a stable laser drive system is a scanned beam display, such as that described in U.S. Pat. No. 5,467,104 of Furness et al., entitled VIRTUAL RETINAL DISPLAY, which is incorporated herein by reference. As shown in FIG. 16A, in a scanned beam display 1602, a scanning source 1604 outputs a scanned beam of light that is coupled to a viewer's eye 1606 by a beam combiner 1608. In scanned displays, a scanner, such as a scanning mirror or acousto-optic scanner, scans a modulated light beam onto a viewer's retina. An example of such a scanner is described in U.S. Pat. No. 5,557,444 to Melville et al., entitled MINIATURE OPTICAL SCANNER FOR A TWO-AXIS SCANNING SYSTEM, which is incorporated herein by reference. The scanned light enters the eye 1606 through the viewer's pupil 1610 and is imaged onto the retina 1612 by the cornea. In response to the scanned light the viewer perceives an image.

Sometimes such displays are used for partial or augmented view applications. In such applications, a portion of the display is positioned in the user's field of view and presents an image that occupies a region of the user's field of view. The user can thus see both a displayed virtual image and background information 1614. If the background light is occluded, the viewer perceives only the virtual image.

FIG. 16B shows some additional detail of some components of the scanning source 1604 of FIG. 16A in the context of a head up display in a motor vehicle 1615, according to an embodiment. A controller 1616 receives information for display from interface 1618. Such information may comprise video data or alternatively may comprise sensor data. In the case where the interface 1618 provides sensor data, the controller 1616 selects sensor data and formats it into video. The controller 1616 modulates light sources 1620, 1622, and 1624, which may be for example, a red laser diode, a green frequency doubled laser, and a blue frequency doubled laser, respectively. As is described above, the video format may comprise variable brightness pixels that nominally would create non-constant power dissipation in the light sources 1620, 1622, and 1624. The controller may format the video data in a manner that results in a relatively uniform distribution of pixel brightness across the field of view by selecting where and how to display information across the field of view. Alternatively or additionally, the controller may provide thermal compensation waveforms to one or all the light sources 1620, 1622, and/or 1624 in manners described above. In the example where a red laser 1620 is not particularly sensitive to variations in temperature but a green laser 1622 and a blue laser 1624 are sensitive to variations in temperature, the controller 1616 may provide thermal compensation waveforms only to green laser 1622 and blue laser 1624.

The light sources 1620, 1622, and 1624 emit modulated beams of light at respective wavelengths into a beam combiner 1626 that combines the modulated beams into a single modulated beam 1628. A beam shaping optic 1630, such as a collimator, a top-hat converter, an astigmatism corrector, etc. shapes the beam 1628 and directs it toward a scan mirror 1632. Controller 1622 drives the scan mirror 1632 to, in combination with the light sources 1620, 1622, and 1624, provide a scan pattern that may be perceived by the user's eye 1606 as an image. Scan mirror 1632 thus creates a scanned beam of modulated light 1634. Scanned beam 1634 is reflected by an optional mirror 1636 toward a final combining optic 1638. In some cases, final combining optic 1638 may be the windshield of a motor vehicle. Thus the scan source 1604, in combination with the optional mirror 1636 and final combining optic 1638 provides a see-through display to the user 1606.

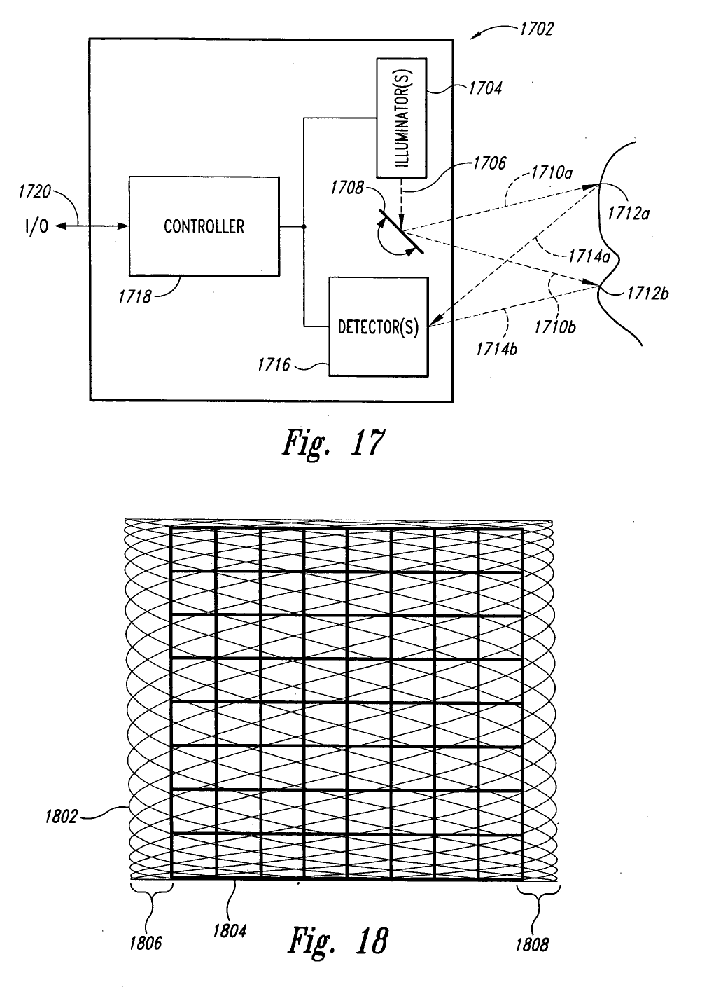

In addition to finding application in scanned beam imaging systems such as those shown in FIGS. 16A and 16B, embodiments of the method and apparatus for stable laser drive may be used in scanned beam image capture systems. FIG. 17 is a diagram illustrating some of the principal components of an RGB scanned laser beam image capture device 1702 according to an embodiment.

An illuminator 1704 creates a first beam of light 1706. A scanner 1708 deflects the first beam of light across a field-of-view (FOV) to produce a second scanned beam of light 1710, shown in two positions 1710a and 1710b. The scanned beam of light 1710 sequentially illuminates spots 1712 in the FOV, shown as positions 1712a and 1712b, corresponding to beam positions 1710a and 1710b, respectively. While the beam 1710 illuminates the spots 1712, the illuminating light beam 1710 is reflected, absorbed, scattered, refracted, wavelength shifted, or otherwise affected by the properties of the object or material to produce scattered light energy. A portion of the scattered light energy 1714, shown emanating from spot positions 1712a and 1712b as scattered energy rays 1714a and 1714b, respectively, travels to one or more detectors 1716 that receive the light and produce electrical signals corresponding to the amount of light energy received. The electrical signals drive a controller 1718 that builds up a digital image and transmits it for further processing, decoding, archiving, printing, display, or other treatment or use via interface 1720.

Light source 1704 may comprise multiple emitters such as, for instance, light emitting diodes (LEDs), lasers, thermal sources, arc sources, fluorescent sources, gas discharge sources, or other types of illuminators. In some embodiments, illuminator 1704 comprises a laser that is temperature-sensitive. In such embodiments, circuitry in the controller 1718 may provide thermal dissipation compensation signals as taught herein.

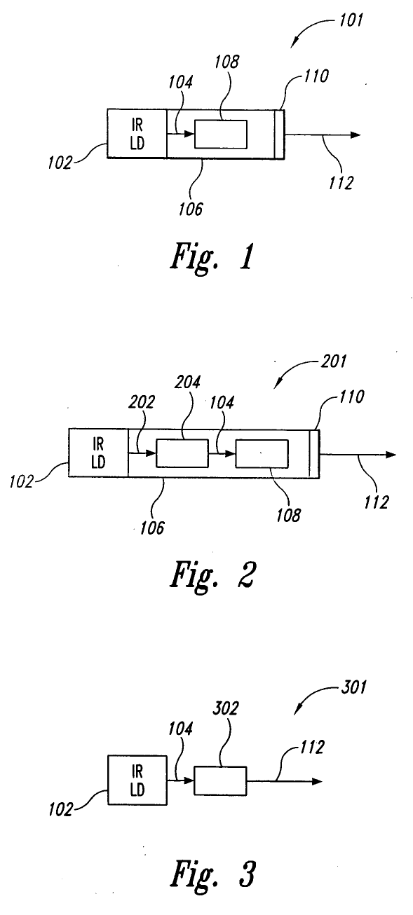

In some embodiments, light source 1704 comprises a red laser diode having a wavelength of approximately 635 to 670 nm, a violet or blue laser diode or diode-pumped solid-state (DPSS) laser having a wavelength of approximately 415 to 473 nm, and a green laser providing a green laser beam having a wavelength of about 532 nm. The green laser may be a DPSS and/or a type of laser that uses second harmonic generation to convert 1064 nm light to 532 nm light, such as is shown in FIGS. 1-3. Other types of lasers may be interchanged and/or combined, wherein at least one of the lasers possesses a temperature sensitivity that is accommodated using compensation pulses. One or more of the lasers may optionally be externally modulated. In the case where an external modulator is used, it is considered part of light source 1704. Similarly, light source 1704 may comprise other types of light emitters such as one or more light emitting diodes (LEDs).

Light source 1704 may include, in the case of multiple emitters, beam combining optics to combine some or all of the emitters into a single beam. Light source 1704 may also include beam-shaping optics such as one or more collimating lenses and/or apertures. Additionally, while the wavelengths described in the previous embodiments have been in the optically visible range, other wavelengths may be within the scope of the invention.

Light beam 1706, while illustrated as a single beam, may comprise a plurality of beams converging on a single scanner 1708 or onto separate scanners 1708.

Some embodiments of scanned beam displays and scanned beam image capture systems use a MEMS scanner 1632, 1708. A MEMS scanner may be of a type described in, for example; U.S. Pat. No. 6,140,979, entitled SCANNED DISPLAY WITH PINCH, TIMING, AND DISTORTION CORRECTION and commonly assigned herewith; U.S. Pat. No. 6,245,590, entitled FREQUENCY TUNABLE RESONANT SCANNER AND METHOD OF MAKING and commonly assigned herewith; U.S. Pat. No. 6,285,489, entitled FREQUENCY TUNABLE RESONANT SCANNER WITH AUXILIARY ARMS and commonly assigned herewith; U.S. Pat. No. 6,331,909, entitled FREQUENCY TUNABLE RESONANT SCANNER and commonly assigned herewith; U.S. Pat. No. 6,362,912, entitled SCANNED IMAGING APPARATUS WITH SWITCHED FEEDS and commonly assigned herewith; U.S. Pat. No. 6,384,406, entitled ACTIVE TUNING OF A TORSIONAL RESONANT STRUCTURE and commonly assigned herewith; U.S. Pat. No. 6,433,907, entitled SCANNED DISPLAY WITH PLURALITY OF SCANNING ASSEMBLIES and commonly assigned herewith; U.S. Pat. No. 6,512,622, entitled ACTIVE TUNING OF A TORSIONAL RESONANT STRUCTURE and commonly assigned herewith; U.S. Pat. No. 6,515,278, entitled FREQUENCY TUNABLE RESONANT SCANNER AND METHOD OF MAKING and commonly assigned herewith; U.S. Pat. No. 6,515,781, entitled SCANNED IMAGING APPARATUS WITH SWITCHED FEEDS and commonly assigned herewith; and/or U.S. Pat. No. 6,525,310, entitled FREQUENCY TUNABLE RESONANT SCANNER and commonly assigned herewith; all hereby incorporated by reference.

A 2D MEMS scanner 108 scans one or more light beams at high speed in a pattern that covers an entire 2D FOV or a selected region of a 2D FOV within a frame period. A typical frame rate may be 60 Hz, for example. Often, it is advantageous to run one or both scan axes resonantly. In one embodiment, one axis is run resonantly at about 19 KHz while the other axis is run non-resonantly in a sawtooth pattern so as to create a progressive scan pattern. A progressively scanned bi-directional approach with a single beam scanning horizontally at scan frequency of approximately 19 KHz and scanning vertically in sawtooth pattern at 60 Hz can approximate an SVGA resolution. In one such system, the horizontal scan motion is driven electrostatically and the vertical scan motion is driven magnetically. Alternatively, both the horizontal and vertical scan may be driven magnetically or capacitively. Electrostatic driving may include electrostatic plates, comb drives or similar approaches. In various embodiments, both axes may be driven sinusoidally or resonantly.

Several types of detectors may be appropriate, depending upon the application or configuration. For example, in one embodiment, the detector may include a simple PIN photodiode connected to an amplifier and digitizer. In this configuration, beam position information may be retrieved from the scanner or, alternatively, from optical mechanisms, and image resolution is determined by the size and shape of scanning spot 1712. In the case of multi-color imaging, the detector 1716 may comprise more sophisticated splitting and filtering to separate the scattered light into its component parts prior to detection. As alternatives to PIN photodiodes, avalanche photodiodes (APDs) or photomultiplier tubes (PMTs) may be preferred for certain applications, particularly low light applications.

In various approaches, simple photodetectors such as PIN photodiodes, APDs, and PMTs may be arranged to stare at the entire FOV, stare at a portion of the FOV, collect light retrocollectively, or collect light confocally, depending upon the application. In some embodiments, the photodetector 1716 collects light through filters to eliminate much of the ambient light.

The scanned beam image capture system 1702 may be embodied as monochrome, as full-color, and even as a hyper-spectral. In some embodiments, it may also be desirable to add color channels between the conventional RGB channels used for many color cameras.

In some embodiments, the illuminator may emit a polarized beam of light or a separate polarizer (not shown) may be used to polarize the beam. In such cases, the detector 1716 may include a polarizer cross-polarized to the scanning beam 1710. Such an arrangement may help to improve image quality by reducing the impact of specular reflections on the image.

High speed MEMS mirrors and other resonant deflectors may be characterized by sinusoidal scan rates, compared to constant rotational velocity scanners such as rotating polygons. To reduce power requirements and size constraints of the scanner, some embodiments may allow both scan axes to scan resonantly.

FIG. 18 is an idealized diagram illustrating a field of view of a scanned beam system according to an embodiment. FIG. 18 illustrates a two-dimensional (2D) beam scan pattern 1802, illustrated by solid lines, overlaying a field of view 1804. A variety of beam scan patterns may be used. The exemplary scan pattern is a Lissajous scan pattern that repeats several top-to-bottom and bottom-to-top vertical cycles per frame while a large number of horizontal cycles are repeated. The amplitudes of the scan pattern 1802 may be selected such that a portion of the scan pattern occurs within the field of view 1804 and other portions of the scan pattern 1806 and 1808 fall outside the field of view.

For resonant scanning systems, constant frequency pulse modulation may be used with constant pixel clock rate and variable pixel spacing. In such a mode, it may be desirable to apply image processing to interpolate between actual sample locations to produce a constant pitch output. In this case, the addressability limit is set at the highest velocity point in the scan as the beam crosses the center of the FOV. More peripheral areas at each end of the scan where the scan beam is moving slower are over-sampled. In general, linear interpolation applied two-dimensionally has been found to yield good image quality and have a relatively modest processing requirement.

Alternatively, constant pixel spacing may be maintained by varying pixel clocking frequency. Methods and apparatus for varying pixel clocking across a FOV are described in U.S. patent application Ser. No. 10/118,861, entitled ELECTRONICALLY SCANNED BEAM DISPLAY, filed Apr. 9, 2002, commonly assigned herewith and incorporated by reference.

As noted above, compensation energy may be selected to provide relatively constant power dissipation in the laser per pixel cycle. Alternatively, and especially when pixel clocking frequency is varied, compensation may be selected to provide relatively constant power dissipation in the laser per unit time. Such a system may be implemented by providing to the compensation processor 1522 in FIG. 15A with information about the instantaneous scan rate and/or the scan position within the scan pattern. For multiple pixel implementations, such information may be combined with future and/or past pixel grayscale values to determine a compensation pattern.

In addition to the continuous or pixel-by-pixel thermal compensation taught herein, scanned beam systems my use overscan areas such as areas 1806 and 1808 to provide additional thermal compensation. That is, for scanned lines that cumulatively provide more nominal heating of the laser than may be desired, the laser may be turned off in the overscan regions 1806 and 1808 to allow it to cool somewhat. Conversely, for scanned lines that cumulatively proved less nominal heating of the laser than may be desired, the laser may be turned on in the overscan regions 1806 and 1808 to allow it to heat somewhat. For applications where the appearance of light in the overscan regions is not objectionable, light emitted from the laser in the overscan regions may be allowed to pass through to a visible location. For applications where the appearance of light in the overscan regions may be objectionable, the overscan regions may be occluded such that light emitted therein is emitted toward a light block that does not allow the light to pass to a visible location.

The preceding overview of the invention, brief description of the drawings, and detailed description describe exemplary embodiments according to the present invention in a manner intended to foster ease of understanding by the reader. Other structures, methods, and equivalents may be within the scope of the invention. For example, while the laser modulation pulses illustrated in the foregoing discussions use amplitude modulation to select a laser brightness, pulse width modulation may be similarly used. Moreover, the system may be used to compensate for the presence or absence of pixels in a substantially single-brightness (non-grayscale) system. One or more sensors may be combined to provide feedback to the system. For example, a temperature sensor may be used in combination with short term pixel-by-pixel compensation to provide noise reduction over extended periods of use, variable use environments, etc. Moreover, one or more optical detectors may be used to provide feedback to the system.

As such, the scope of the invention described herein shall be limited only by the claims.

What is claimed is:

1. A laser controller comprising:
a memory operable to receive and retain a laser pulse history;
a video interface operable to receive a pixel value;
a digital-to-analog converter;
a laser drive coupled to the digital-to-analog converter;
a laser coupled to the laser drive; and
a processor coupled to the video interface, the memory, and the digital-to-analog converter;
wherein the processor is operable to receive the pixel value from the video interface;
read the laser pulse history from the memory;
create a laser pulse schedule as a function of the laser pulse history and the pixel value, the laser pulse schedule including lasing and non-lasing portions;
write the laser pulse schedule to the digital-to-analog converter; and
write the pixel value to the memory to update the laser pulse history.

2. The laser controller of claim 1 wherein the non-lasing portion of the laser pulse schedule includes a value below the lasing threshold of the laser.

3. The laser controller of claim 1 wherein the non-lasing portion of the laser pulse schedule includes on-pulses shorter than the response time of the laser.

4. The laser controller of claim 1 wherein the non-lasing portion of the laser pulse schedule includes a value above a roll-over threshold of the laser.

5. The laser controller of claim 1 wherein the laser has a periodic field-of-view and the non-lasing portion of the laser pulse schedule includes a laser pulse timed to fall outside the field-of-view of the laser.

6. The laser controller of claim 1 wherein the laser includes a non-lasing current path and the non-lasing portion of the laser pulse schedule is configured to provide current to the non-lasing current path.

7. The laser controller of claim 1 wherein the laser includes a SHG laser.

8. The laser controller of claim 1 wherein the non-lasing portion of the laser pulse schedule is selected to maintain substantially constant temperature in the laser.

9. The laser controller of claim 1 wherein the laser is characterized by a plurality of modes and the non-lasing portion of the laser pulse schedule is selected to maintain one of the plurality of modes.

10. The laser controller of claim 1 further comprising a wherein the pixel value received from the video interface includes a future pixel value.

11. A method for controlling a laser comprising:
receiving a first laser device modulation pattern corresponding to a desired pattern of laser beam emission;
determining from the first laser device modulation pattern a second laser device modulation pattern corresponding to the desired pattern of laser beam emission and corresponding to a desired pattern of laser device power dissipation; and
outputting the second laser device modulation pattern.

12. The method for controlling a laser of claim 11 wherein the second laser device modulation pattern includes a laser cavity modulation pattern and a laser heater modulation pattern.

13. The method for controlling a laser of claim 11 wherein the second laser device modulation pattern includes a pattern of modulation above a lasing threshold voltage and a pattern of modulation below the lasing threshold voltage.

14. The method for controlling a laser of claim 11 wherein the second laser device modulation pattern includes a pattern of modulation below a rollover voltage and a pattern of modulation above the rollover voltage.

15. The method for controlling a laser of claim 11 wherein the second laser device modulation pattern includes a pattern corresponding to laser emission within a field of view and a pattern corresponding to power dissipation outside the field of view.

16. The method for controlling a laser of claim 15 wherein the pattern corresponding to power dissipation outside the field of view also corresponds at least partly to a pattern of laser emission outside the field of view.

17. A variable output laser system comprising;
a laser controller operable to output a laser energization signal including illumination and thermal compensation pulses; and
a SHG laser coupled to the controller, operable to receive the energization signal and responsively emit a beam of light when receiving an illumination pulse and undergo heating when receiving a compensation pulse;

18. The variable output laser system of claim 17 wherein the SHG laser is characterized by a lasing threshold current and the thermal compensation pulses include portions less than the lasing threshold current.

19. The variable output laser system of claim 17 wherein the SHG laser is characterized by a response time and the thermal compensation pulses include drive portions having duration less than the response time.

20. The variable output laser system of claim 17 wherein the SHG laser is characterized by a rollover current and the thermal compensation pulses include portions greater than the rollover current.

21. The variable output laser system of claim 17 further comprising a beam director operable to scan the beam of light across a field of view in a periodic pattern.

22. The variable output laser system of claim 21 wherein the compensation pulses correspond to times when the beam of light is outside the field of view.

23. The variable output laser system of claim 21 further comprising an interface configured for coupling to a video source and coupled to the laser controller.

24. The variable output laser system of claim 23 wherein points where the beam of light is emitted responsive to the illumination pulses correspond to illuminated pixels.

25. The variable output laser system of claim 24 further comprising a light detector operable to receive emitted light backscattered from the field of view and a decoder operable to assemble an image from the received backscattered light.

26. The variable output laser system of claim 24 wherein the illumination pulses correspond to a viewable video image.

27. The variable output laser system of claim 24 further comprising a photoconductor in the field of view and the illumination pulses correspond to pixels of a latent image that may be formed on the photoconductor.

28. A method for producing a variable output laser beam comprising the steps of;
outputting a laser energization signal including illumination and thermal compensation pulses from a laser controller; and
receiving the energization signal in a SHG laser and responsively emitting a beam of light when receiving an illumination pulse and undergoing heating when receiving a compensation pulse;

29. The method for producing a variable output laser beam of claim 28 wherein the SHG laser is characterized by a lasing threshold current and the thermal compensation pulses include portions less than the lasing threshold current.

30. The method for producing a variable output laser beam of claim 28 wherein the SHG laser is characterized by a response time and the thermal compensation pulses include drive portions having duration less than the response time.

31. The method for producing a variable output laser beam of claim 28 wherein the SHG laser is characterized by a rollover current and the thermal compensation pulses include portions greater than the rollover current.

32. The method for producing a variable output laser beam of claim 28 further comprising the step of receiving the beam of light at a beam director and scanning the beam of light across a field of view in a periodic pattern.

33. The method for producing a variable output laser beam of claim 32 wherein the compensation pulses correspond to times when the beam of light is outside the field of view.

34. The method for producing a variable output laser beam of claim 32 further comprising the step of receiving a video signal from a video source through an interface coupled to the laser controller.

35. The method for producing a variable output laser beam of claim 34 wherein points where the beam of light is emitted responsive to the illumination pulses correspond to illuminated pixels.

36. The method for producing a variable output laser beam of claim 35 further comprising the steps of:
receiving emitted light backscattered from the field of view at a light detector; and
decoding the received backscattered light to assemble an image.

37. The method for producing a variable output laser beam of claim 35 further comprising the step of producing a viewable image from the illumination pulses.

38. The method for producing a variable output laser beam of claim 35 further comprising receiving the illumination pulses at a photoconductor to form a latent image corresponding to the illumination pulses.
